(19) United States
(12) Patent Application Publication
(10) Pub. No.: US 2022/0261958 A1
(43) Pub. Date: Aug. 18, 2022

(54) GENERATING SUPER RESOLUTION IMAGES USING NON-COLOR INFORMATION WITH A DEEP-LEARNING NEURAL NETWORK

(71) Applicant: QUALCOMM Incorporated, San Diego, CA (US)

(72) Inventors: Pavan Kumar AKKARAJU, Bangalore (IN); Shwetank SINGH, Bangalore (IN); Siva Rama Krishna Reddy BOGI REDDY, Bengaluru (IN); Kalyan Kumar BHIRAVABHATLA, Bengaluru (IN)

(21) Appl. No.: 17/177,684

(22) Filed: Feb. 17, 2021

(51) Int. Cl. G06T 3/40; G06T 7/55; G06T 7/90; G06T 5/20; G06T 1/20

(52) U.S. Cl. CPC G06T 3/4053; G06T 7/55; G06T 2207/20084; G06T 5/20; G06T 1/20; G06T 7/90

(57) ABSTRACT

The present disclosure relates to methods and apparatus for graphics processing. An example method generally includes rendering, by a graphics processing unit (GPU), a first image using a subset of data in a frame buffer corresponding to a first frame, the first image being rendered at a first resolution, the first image comprising a plurality of color component values; generating, using a neural network, a second image corresponding to a higher resolution version of the first image, the second image having a second resolution higher than the first resolution, wherein the neural network uses as input the first image and one or more non-color information corresponding to the first frame and computed by the GPU; and outputting the second image for display.

The present disclosure relates generally to processing systems and, more particularly, to one or more techniques for graphics processing.

### BACKGROUND

Digital image scale-up operations may sometimes be referred to as super resolution operations. For example, using a super resolution operation, a 4k (3840 by 2160 pixels) resolution display output may be scaled up from a 1080p (1920 by 1080 pixels) resolution input. Such super resolution operations may apply to different resolutions depending on specific applications (e.g., from 4k to 7680 by 4320 pixels). There are different algorithms to scale up images to higher resolutions, each achieving different levels of restoration (e.g., if compressed or scaled-down previously), realism (e.g., if artificially generated), and/or accuracy (e.g., if a scene of reality available for comparison).

Machine learning, such as by employing deep learning neural networks, can often achieve better results in terms of restoration, realism, or accuracy than pre-defined algorithms (e.g., bicubic). In some instances, part of the deep learning networks generates one or more scaled-up versions of the input, and another part compares and rates the scaled-up versions to a set of reference images to identify a way of processing (e.g., learning one or more parameters) resulting in a desired output. The way of processing is thus “learned” by the super resolution networks instead of being pre-programmed. However, such machine learning often results in different levels of performance due to several factors, including at least: variables and abilities to generate different scaled-up versions; a proper way to compare and score the scaled-up versions to references; and the sample size of the references, among others. To achieve highly realistic results, it is desirable to improve these factors/aspects to improve machine learning in super resolution operations.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, an apparatus, and a computing device are provided.

In certain aspects, an example method generally includes rendering, by a graphics processing unit (GPU), a first image using a subset of data in a frame buffer corresponding to a first frame, the first image being rendered at a first resolution. The first image comprises a plurality of color component values. The method generally includes generating, using a neural network, a second image corresponding to a higher resolution version of the first image, the second image having a second resolution higher than the first resolution. The neural network uses as input the first image and one or more non-color information corresponding to the first frame and computed by the GPU. The method generally includes outputting the second image for display.

In certain aspects, an example apparatus generally includes a communication interface, a graphical processing unit (GPU), and a display processing unit. The communication interface is in communication with a neural network processor. The GPU is configured to render a first image using a subset of data in a frame buffer corresponding to a first frame. The first image is rendered at a first resolution. The first image includes a plurality of color component values. The GPU is configured to compute one or more non-color information corresponding to the first frame and provide the one or more non-color information to the neural network processor for generating a second image corresponding to a higher resolution version of the first image. The second image has a second resolution higher than the first resolution. The neural network processor uses as input the first image and one or more non-color information corresponding to the first frame and computed by the GPU. The display processing unit is configured to output the second image for display.

In certain aspects, an example computing device generally includes a central processing unit (CPU), a communication interface, a graphics processing unit (GPU), and a display. The communication interface is in communication with a neural network processor. The GPU is configured to render a first image using a subset of data in a frame buffer corresponding to a first frame. The first image is rendered at a first resolution. The first image comprises a plurality of color component values. The GPU is configured to compute one or more non-color information corresponding to the first frame and provide the one or more non-color information to the neural network processor for generating a second image corresponding to a higher resolution version of the first image. The second image has a second resolution higher than the first resolution. The neural network processor uses as input the first image and one or more non-color information corresponding to the first frame and computed by the GPU. The display is configured to output the second image.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system, in accordance with certain aspects of the present disclosure.

FIG. 2 illustrates an example process block diagram for generating super resolution images, in accordance with certain aspects of the present disclosure.

FIG. 3 illustrates an example diagram implementing a modified super resolution generative adversarial networks (SRGAN), in accordance with certain aspects of the present disclosure.

FIG. 4 illustrates an example generator portion of the modified SRGAN of FIG. 3, in accordance with certain aspects of the present disclosure.

FIG. 5 illustrates an example discriminator portion of the modified SRGAN of FIG. 3, in accordance with certain aspects of the present disclosure.

FIG. 6 illustrates a flow diagram of example operations for performing super resolution operations using non-color information computed by a graphics processing unit (GPU) with a modified SRGAN, in accordance with certain aspects of the present disclosure.

Like numerals indicate like elements.

### DETAILED DESCRIPTION

The present disclosure provides techniques to perform super resolution operations using non-color information, such as in a deep learning neural network to achieve highly realistic and accurate results. In certain aspects, the non-color information, includes one or more of depth, texture, or normal at the lower resolution. In certain aspects, the non-color information is computed by a graphical processing unit (GPU) and may be information not typically available for standard images or videos that are not graphics generated by a GPU. Accordingly, in certain aspects, such non-color information computed by a GPU may be referred to as GPU specific information. For example, to save computational workload and improve power efficiency, the GPU may generate a lower resolution frame, such as at a lower resolution than the desired output resolution (e.g., when the display output is 4k, the GPU needs only compute at 1080p). The lower resolution frame may include color values for pixels of the frame, which may be referred to as conventional color information. Further, in certain aspects, the GPU provides non-color information computed for the lower resolution image to a modified super resolution generative adversarial network (SRGAN). The modified SRGAN uses the non-color information, along with the conventional color information, to generate scaled-up versions of the frame at the desired output resolution. The modified SRGAN includes a discriminator network that compares the scaled-up versions of the frame to a reference database and employs a loss function that determines the final output. In certain embodiments, the SRGAN processor may learn over operations without human intervention.

In a general aspect, the disclosed techniques includes rendering, by the GPU, a first image using a subset of data in a frame buffer corresponding to a first frame. The first image being rendered at a first resolution. The first image comprises a plurality of color component values. A neural network, such as the modified SRGAN, is used to generate a second image corresponding to a higher resolution version of the first image. The second image has a second resolution higher than the first resolution. For example, the second resolution may be at least four times the first resolution. The neural network uses as input the first image and one or more non-color information (e.g., depth, texture, normal, etc.) corresponding to the first frame and computed by the GPU. The second image is outputted for display. As such, this disclosure provides methods and devices for an end-to-end flow for applications and GPU processing at a relatively low resolution, followed by a machine-learning algorithm that runs on an accelerator (e.g., SRGAN) to upscale the first image to the second image at the second resolution for the frame.

As discussed herein, the modified deep learning neural network takes advantage of the non-color information, such as computed by the GPU, along with traditional color information (e.g., RGB or CMYK components) to attempt to make the generated frame as visually non-distinguishable as possible from a reference high resolution frame (used for validation). By having the GPU process only a subset of data in the frame buffer, the disclosed techniques are suitable for computation demanding applications, such as in contexts of high frame rates of real-time rendering, and for energy sensitive applications, such as when the GPU is battery powered.

Conventionally, GPUs for mobile applications are often limited due to power budgets. Present market trends demand higher resolutions (e.g., 4k and higher) and refresh rates (144 Hz and beyond), even for mobile applications. Thus improved performance of the GPU face high demand. Advancements in artificial intelligence (AI) and machine learning (ML) enables GPUs to process the subset of data instead of all data in the frame buffer. High resolution images need only be reconstructed with AI/ML after the GPU processing the subset of data. In addition, the non-color information computed by the GPU enhances the performance of the AI/ML, resulting in more realistic and accurate scaling up performance.

Existing super resolution (SR) networks are usually either too heavy for mobile power/performance budgets or compromise on quality. Furthermore, known SR networks are limited to receiving color data from existing images as input. For example, most SR networks are built for processing camera/video RGB images.

The present disclosure provides methods, devices, and systems for generating a super resolution image from a low resolution image using non-color information, such as computed by a GPU, in a neural network. For example, one implementation may include a very high-resolution display driven by a low or mid tier GPU. As such, a system may still be able to support higher resolutions and/or higher framerates within mobile GPU/SOC budgets. In a second implementation, this disclosure may be used in power and performance optimized GPU rendering. For example, low resolution graphic operations at CPU and GPU level may save significant power resource and result in very good performance numbers (e.g., in terms of frames per second, or FPS). Such power saving with performance improvement can result in significant improvement for resource sensitive applications or products, such as in gaming, or augmented reality (AR) and virtual reality (VR) related applications. This disclosure may also be implemented in an architecture that improves an overall hardware utilization, such as with GPU rendering micro-language internet protocol (MLIP) cores.

The present disclosure introduces depth-wise and point-wise convolutions in a modified SRGAN based on depth information, such as during real-time rendering. Other non-color information, such as texture and normal information, may also be input to the modified SRGAN. In addition, at early layers of the generator and/or discriminator of the SRGAN, feature maps are increased (e.g., partly in response to the added depth information). In some cases, the number of mid-blocks (e.g., stackable mid-block includes a series of routine operations) can vary to achieve sufficient depth for the network.

The following description will not reiterate known examples of SRGAN application for images and videos, such as “Photo-Realistic Single Image Super-Resolution Using a Generative Adversarial Network” by Ledig et al. (arXiv:1609.04802v5 [cs.CV] 25 May 2017, referred to as “Ledgic's SRGAN”), which are fully incorporated by reference herein. The following description focuses on the modification and distinguishing aspects from known SRGAN. Importantly, the modified SRGAN herein does not require all elements or same/similar configurations of existing SRGAN examples. Therefore, Ledig's SRGAN, or other similar SRGAN applications, if referenced to, cannot be used to limit the claimed modified SRGAN in any manner contradictory to or inconsistent with the present disclosure.

Various aspects of systems, apparatuses, computer program products, and methods are described more fully hereinafter on generating super resolution images using non-color information and deep-learning neural network. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method, which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different graphics technologies, system configurations, etc., some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline in a single device or multiple devices, or a single device having multiple pipelines, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit (DPU). Graphical content may be processed to become display content. For example, a graphics processing unit may output graphical content, such as a frame, to a buffer (which may be referred to as a framebuffer). A DPU may read the graphical content, such as one or more frames from the buffer, and perform one or more display processing techniques thereon to generate display content. For example, a DPU may be configured to perform composition on one or more rendered layers to generate a frame. As another example, a DPU may be configured to compose, blend, or otherwise combine two or more layers together into a single frame. A DPU may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

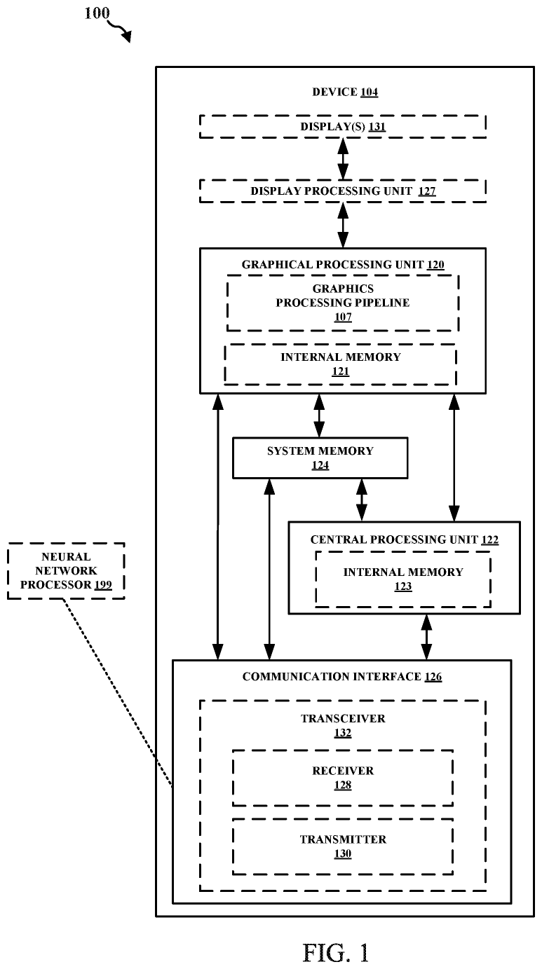

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a GPU 120, a CPU 122, and a system memory 124. In some aspects, the device 104 can include a number of optional components, e.g., a communication interface 126, a transceiver 132, a receiver 128, a transmitter 130, a DPU 127, and one or more displays 131.

Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this can be referred to as split-rendering.

The GPU 120 may include an internal memory 121. The GPU 120 may be configured to perform graphics processing, such as in a graphics processing pipeline 107. The CPU 122 may include an internal memory 123. In some examples, the device 104 may include a display processor, such as the DPU 127, to perform one or more display processing techniques on one or more frames generated by the GPU 120 before presentment by the one or more displays 131. The DPU 127 may be configured to perform display processing. For example, the DPU 127 may be configured to perform one or more display processing techniques on one or more frames generated by the GPU 120. The one or more displays 131 may be configured to display or otherwise present frames processed by the DPU 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the GPU 120 and the CPU 122, such as system memory 124, may be accessible to the GPU 120 and the CPU 122. For example, the GPU 120 and the CPU 122 may be configured to read from and/or write to external memory, such as the system memory 124. The GPU 120 and the CPU 122 may be communicatively coupled to the system memory 124 over a bus. In some examples, the GPU 120 and the CPU 122 may be communicatively coupled to each other over the bus or a different connection.

The CPU 122 may be configured to receive graphical content from any source, such as the system memory 124 and/or the communication interface 126. The system memory 124 may be configured to store received encoded or decoded graphical content. The CPU 122 may be configured to receive encoded or decoded graphical content, e.g., from the system memory 124 and/or the communication interface 126, in the form of encoded pixel data. The CPU 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The GPU 120 may be a general purpose GPU (GPGPU), or any other processing unit that may be configured to perform graphics processing. In some examples, the GPU 120 may be integrated into a motherboard of the device 104. In some examples, the GPU 120 may be present on a graphics card that is installed in a port in a motherboard of the device 104, or may be otherwise incorporated within a peripheral device configured to interoperate with the device 104. The GPU 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the GPU 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The CPU 122 may be any processing unit configured to send instructions to the GPU 120 and perform general computational processing (e.g., non-graphical processing). In some examples, the CPU 122 may be integrated into a motherboard of the device 104. The CPU 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the CPU 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include an optional communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

The content generation system 100 can be coupled with a neural network processor 199. As shown, the neural network processor 199 couples with the GPU 120 via the communication interface 126. In some cases, the neural network processor 199 may couple directly with the GPU 120 or may be part of the content generation system 100. As further described below, the neural network processor 199 may receive input and/or instructions from the GPU 120, the CPU 122, and the system memory 124, such as to perform super resolution operations to scale up image content and output the scaled-up content to the DPU 127 (or directly to the display(s) 131). The neural network process 199 may be implemented, for example, by a suitable processor such as a neural processing unit (NPU), DPU, CPU, etc.

Referring again to FIG. 1, in certain aspects, the graphics processing pipeline 107 may include a subset of data in a frame buffer. The frame buffer may refer to one or more of internal memory 121, system memory 124, or internal memory 123. In certain aspects, the frame buffer refers to a portion of system memory 124. The subset of data corresponds to a first frame. The GPU 120 renders a first image using the subset of data corresponding to the first frame. The first image is to be rendered at a first resolution by the GPU. The first image comprises a plurality of color component values.

The neural network processor 199 generates a second image corresponding to a higher resolution version of the first image. The second image has a second resolution higher than the first resolution. The neural network processor 199 uses the as input the first image (e.g., its color component values) and one or more non-color information corresponding to the first frame and computed by the GPU 120. For example, the non-color information may include at least one of depth information, texture information, or normal information, such as computed by the GPU 120 during rending operations. The neural network processor 199, after generating the second image, outputs the second image to the display 131 for display, such as via DPU 127.

Although illustrated as a separate and external component in FIG. 1, the neural network processor 199, or one or more components thereof, may be integrated or part of the device 104. For example, the neural network processor 199, or part thereof, may be integrated with the GPU 120 or the CPU 122, on a hardware or software level, or both. In some cases, the operational functionality may be used to define what hardware or component of the device 104 may be considered or defined as part of the neural network processor 199. In some cases, the neural network processor 199 may include an array of interconnected processors across a network, operating in serial, parallel, or combination of both. The techniques and methods disclosed herein may be applicable to a wide range of interconnected components, regardless whether such components have dedicated functions to perform certain tasks.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular hardware component (e.g., a GPU), but, in further embodiments, can be performed using other hardware components (e.g., a CPU), consistent with disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit that indicates which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

### Example Generating Super Resolution Images Using Non-Color Information and Deep-Learning Neural Network

The present disclosure relates generally to processing systems and, more particularly, to one or more techniques for graphics processing. For example, as discussed, by using non-color information as input to a modified SRGAN, only a subset (e.g., 25%) of the data corresponding to the final output image resolution needs be processed to achieve high frame rate and high resolution. As the GPU renders at a lower resolution, the disclosed techniques significantly save CPU and GPU resources, especially in mobile applications (e.g., running high frame rate and high definition rendering on mobile devices, such as smart phones). Unlike known SRGAN examples where only a fraction of this savings are spent on MLIP cores, the disclosed techniques maintain both special and stochastic consistency in the quality metrics. Furthermore, the disclosed modified SRGAN produces high quality images comparable to high-resolution reference images with marginal increase in compute resources.

In one illustrative example, super resolution operations are conducted with 640×360 being low resolution, with a 2× super resolution, the network results 1280×720. The modified SRGAN has better network operations than known SRGAN examples due to the added non-color information input to the generator portion 400, e.g., 1137 gigaFLOPS to 1270 gigaFLOPS. It should be understood that other resolutions and scaling factors may be used.

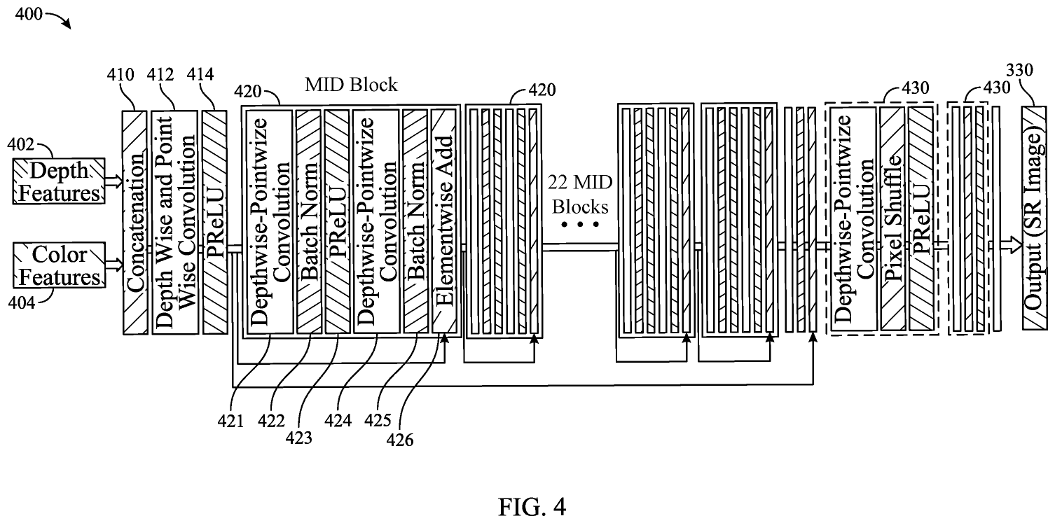

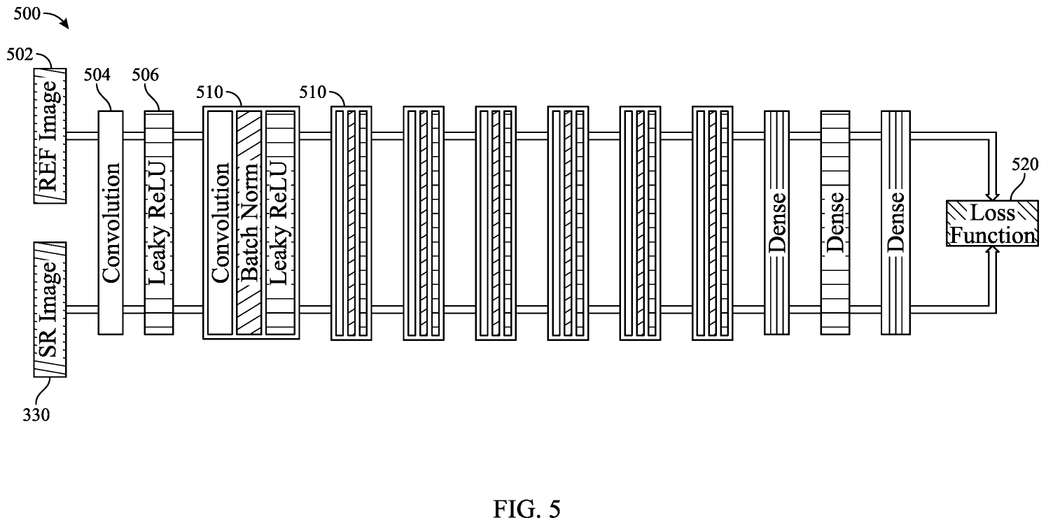

In certain aspects, the modified SRGAN employs system architecture that uses a GPU to force render at a lower output resolution and uses MLIP core(s) to perform super resolution operation on the output of the GPU. In an example, such configuration with the SR deep neural network may be suitable for mobile SOCs that often have power consumption constraints. In certain aspects, the modified SRGAN is configured to suit mobile GPU specific quality and performance requirements including the following factors. In a first example factor, depth wise convolution is used instead of regular convolution that reduces over all networks gigaFLOPS. In a second example factor, the modified SRGAN has network architecture to embed GPU specific feature input. In a third example factor, network architecture modification is trained to improve the quality of output by better discriminator and loss algorithms, as further discussed below regarding FIGS. 4 and 5. In a fourth example factor, quantization of trained network may leverage high speed ALU pipelines with low precision compute (e.g., FP16, INT8).

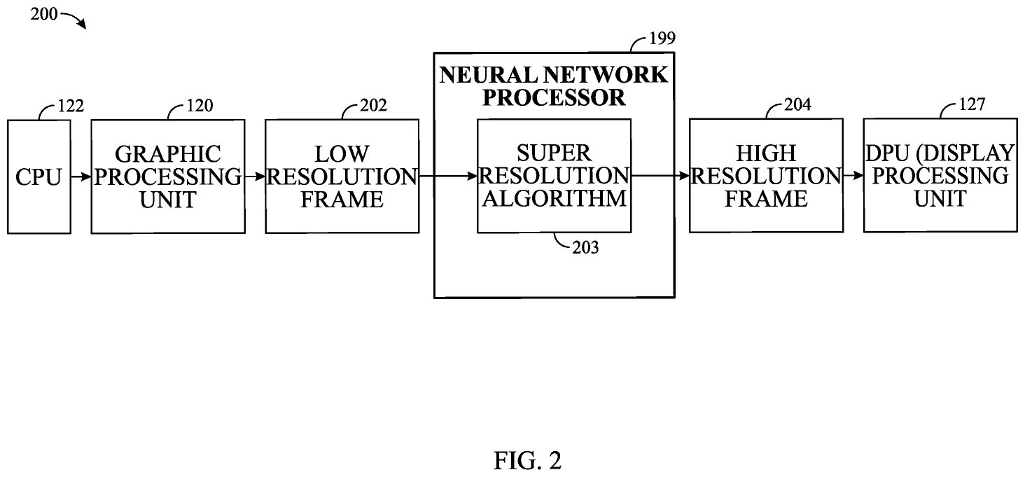

FIG. 2 illustrates an example process block diagram 200 for generating super resolution images, in accordance with certain aspects of the present disclosure. In a general aspect, the CPU 122 sends commands or instructions to the GPU 120 to initiate a rendering process. For example, the CPU 122 may be running game applications and starting rendering threads thereof. The commands sent by the CPU 122 may enable the GPU 120 to access, transfer, or otherwise manipulate data in the memories 124, 123, and 121. Upon receiving the commands, the GPU 120 may perform corresponding rendering operations, including tiling, rasterizing, and resolving. These operations may be performed on a low resolution frame 202 and produce results of various kinds, including color components, depth information, texture information, normal information, and others. Some or all of the output by the GPU 120 related to the low resolution frame 202 is provided to the neural network processor 199. The neural network processor 199 includes and performs based on the super resolution algorithm 203. The neural network processor 199 outputs a high resolution frame 204 to the DPU 127.

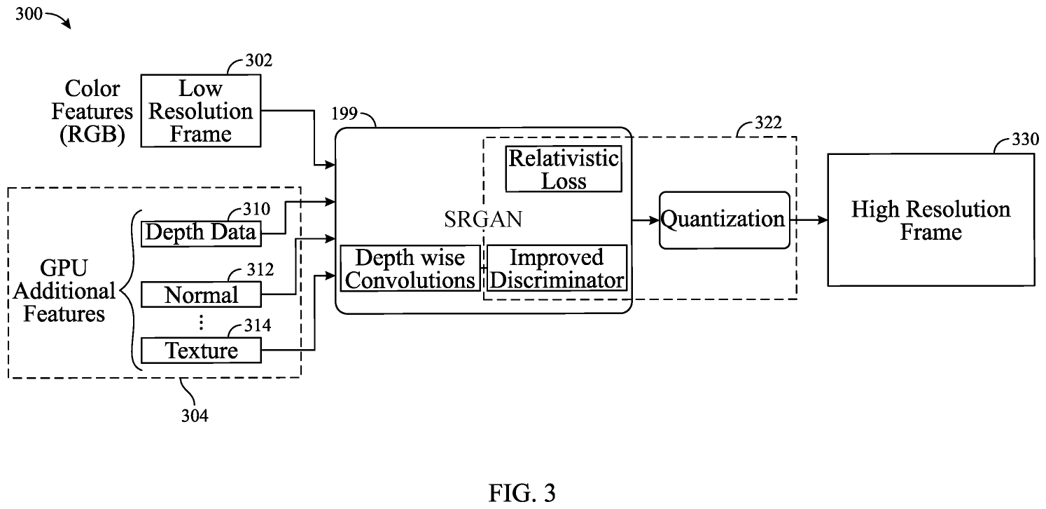

FIG. 3 illustrates an example diagram 300 implementing super resolution generative adversarial networks (SRGAN), in accordance with certain aspects of the present disclosure. The example diagram 300 provides an example for the super resolution algorithm 203 shown in FIG. 2. As shown, in certain embodiments, the neural network processor 199 is implemented as a modified SRGAN. The modified SRGAN takes the color features 302, such as red, green, and blue (RGB) values of the low resolution frame, and non-color features 304 computed by the GPU 120. As shown, the non-color features 304 include one or more of depth information 310, normal information 312, or texture information 314.

The modified SRGAN is differentiated from existing SRGANs in one or more ways. For example, the modified SRGAN may perform an improved discriminator function that employs a relativistic loss function to identify a desired version of the high resolution output, learning the applicable parameters implemented by the neural network processor 199. In another example, the modified SRGAN may perform depthwise convolutions. In particular, using the non-color information 304, the modified SRGAN uses depthwise convolution to generate improved variations of high resolution output. Accordingly, such differentiating features are illustrated in FIG. 3 for ease of understanding. It should be noted that there may be additional distinguishing features as discussed herein.

A quantization process 322 is performed before outputting the high resolution frame 330. The quantization process 322 evaluates effect of quantization. For example, the modified SRGAN quantizes the network using regular quantization methods available in standard framework. such as Tensorflow (or PyTorch) or vendor specific quantization methods (e.g., quantization offered by Qualcomm's SNPE SDK). In certain aspects, the quantization using said methods for 8 bit/16 bit takes advantage of high-speed accelerators specially designed for 8 bit/16 bit operations, thus enhancing the performance with marginal quality compromise.

As shown, the modified SRGAN 199 may receive several enhanced GPU specific inputs. Unlike known SRGAN examples that use only RGB components of image as input, the modified SRGAN 199 accepts additional GPU specific features, such as one or more of depth information, normal information, texture information, etc. The modified SRGAN 199 considers depth attributes Dr, Dg, Db computed by the GPU 120 for each of the color components in addition to the R, G, B color components. Hence the modified SRGAN 199 accepts at least six components (RGB and Dr, Dg, and Db) for each pixel representation of input. Compared to known SRGAN examples, the modified SRGAN 199 includes a modified first layer to accommodate the six components input, instead of three color components. The modified SRGAN also includes more learning parameters for a few more subsequent layers than known SRGAN examples, such as 22 subsequent layers instead of 10 layers of some SRGAN examples. This example is further illustrated in FIGS. 4 and 5. These features enable the modified SRGAN to produce noticeable improvements over known super resolution operation examples, including those that employ SRGAN.

In certain aspects, the modified SRGAN employs depth wise convolution in place of regular convolution, such as in the network of generator of the modified SRGAN. The modified SRGAN replaces convolution layers of known SRGAN examples with a depth wise convolution and point wise convolution combination. The number of mid-blocks (shown in FIGS. 4 and 5) used in the modified SRGAN are further tuned to balance between quality of output (e.g., the higher the quality, the greater computational demand, which may or may not be needed) and computational demand (e.g., gigaFLOPS). In certain aspects, this modification makes the network mobile friendly in terms of performance and power budget.

FIG. 4 illustrates an example generator portion 400 of the modified SRGAN of FIG. 3, in accordance with certain aspects of the present disclosure. As shown, the generator portion 400 receives depth features 402 computed by the GPU 120, along with the color features 404 at the concatenation layer 410. The concatenation layer 410 is followed by the depth wise and point wise convolution layer 412. The convolution layer 412 is followed by a parametric rectified linear unit (PReLU) layer 414. The PReLu layer 414 may learn parameters that control the shape and leaky-ness of the function.

A number of middle blocks (MID blocks) 420 follow the PReLU layer 414. As shown 22 MID blocks 420 are included in the present example, but the total number of MID blocks may vary depending on output quality requirement. The exact number of feature maps (e.g., depth information, texture information, and normal information to be included at the concatenation layer 410) as well as the MID blocks 420 may be adjusted or tuned depending on the desired quality and performance. Each MID block 420 includes a layer 421 of depth wise and point wise convolution, a layer 422 of batch norm, a PReLU layer 423, another layer 424 of depth wise and point wise convolution, another layer 425 of batch norm, and a layer 426 for element wise add.

After the series of MID blocks 420, two or more blocks 430 containing depth wise and point wise convolution, pixel shuffle, and PReLU follow. One or more depth wise and point wise convolution may follow before the super resolution images 330 is output at the last layer. The outputted super resolution images 330 may include two or more versions of predicted super resolution images of a low resolution input image.

FIG. 5 illustrates an example discriminator portion 500 of the SRGAN of FIG. 3, in accordance with certain aspects of the present disclosure. The discriminator portion 500 outputs “logits fake” and “logits real” when comparing the super resolution images 330 generated by the generator portion 400 to a database of reference images 502. The “real” output may be (e.g., the most) accurate or realistic for final output by the neural network processor 199.

The discriminator portion 500 may access reference images 502 and receives the super resolution images 330 from the generator portion 400. The modified SRGAN may use loss network (such as a VGG-19 network) generated features for comparison of predicted images and the reference images to learn corresponding parameters for a desired output. For example, the comparison is over ReLU activated output of features. ReLU by nature suppress all negative values and only positive values are considered. The modified SRGAN enhances the ReLU by removing the ReLU layer at the end of known SRGAN examples, and by letting full-scale features to participate in the comparison.

The reference images 502 and the super resolution images 330 are inputted to the convolution layer 504. A leaky ReLU layer 506 follows the convolution layer 504. The leaky ReLU layer 506 may modify the ReLU function to allow small negative values when the input is less than zero. A series of MID blocks 510 follow the leaky ReLU layer 506. Each of the MID block 510 includes a convolution layer, a batch norm layer, and a leaky ReLU layer. Similar to the MID blocks 420, the number of MID blocks 510 may vary depending on specific applications. The processed reference images and super resolution images are compared at the loss function 520.

The loss function 520 may determine or score a discriminator loss based on values for fake relative and real relative according to the algorithm below.
fake relative=sigmoid (logits fake, mean (logits real))
real relative=sigmoid (logits real, mean (logits fake))
discriminator loss=mean (cross entropy (zeros, fake relative)+cross entropy (ones, real relative))

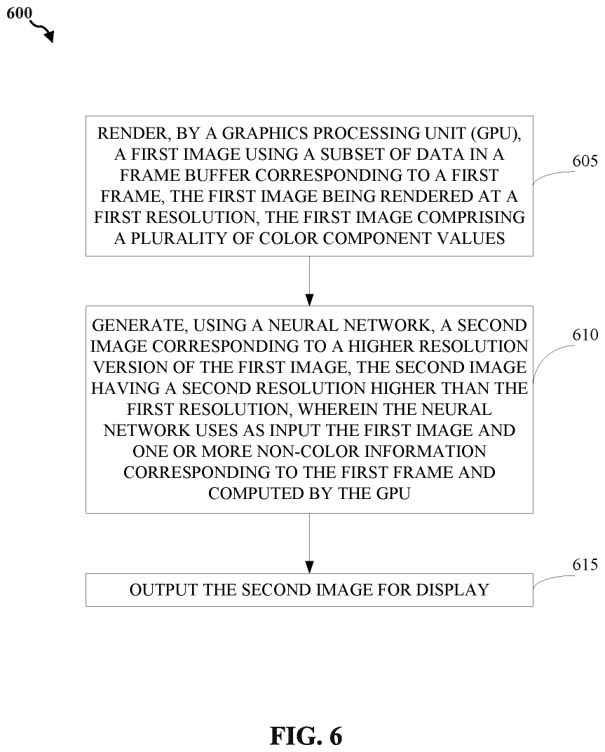

FIG. 6 is an example flow diagram illustrating example operations 600 for graphic processing, such as generating super resolution images with non-color information as input to a deep learning neural network. In certain aspects, the operations 400 may be performed by a GPU in communication with a modified SRGAN, such as respectively the GPU 120 and neuro network processor 199 of FIG. 1.

The operations may begin, at 605, by rendering, by the GPU, a first image using a subset of data in a frame buffer. The subset of data corresponds to a first frame to be rendered at a first resolution. The first image includes a number of color component values. At 610, a neural network (e.g., a modified SRGAN) is used to generate a second image corresponding to a higher resolution version of the first image. The second image has a second resolution higher than the first resolution. The neural network uses as input the first image (i.e., the number of color component values thereof) and one or more non-color information corresponding to the first frame and computed by the GPU. At 615, the second image is outputted for display.

In certain aspects, the one or more non-color information in the frame buffer corresponding to the first frame includes at least one of depth information, texture information, or normal information. For example, the depth information indicates overlapping relationships, lighting/shadow, or other variations related to spatial relations of objects being rendered for certain frame and how such rendering is represented or otherwise affecting the color information in each pixel. The depth information includes depth information of each color component of the color component values. The texture information indicates relationships between graphical information and spatial information based on geometry and/or positions, such as rendering a two-dimensional graphics onto a three dimensional object or determining a three dimensional shape based on a two-dimensional graphics. The normal information may indicate a positive (e.g., convex) direction for a shape or object and a negative (e.g., concave) direction for a shape or object.

Such non-color information may be extracted from the color components, or otherwise be generated as a result of model rendering processes. For example, the initial frame buffer may include only the plurality of color component values of the first frame. The GPU uses the color component values to compute the depth information, texture information, and/or normal information. In some cases, the frame buffer includes data for generating the color and non-color information in real time, i.e., not storing the color component values directly. As such, the GPU computes both the color component values and non-color information on demand. In some cases, the non-color information may exist in another form (e.g., results computed by the CPU or otherwise available in the frame buffer) and is converted to a different format by the GPU. In some cases, the GPU receives instructions or commands from the CPU to render the first image using the subset of data.

In certain aspects, generating the second image using the neural network includes generating, via a generation network (or a generator portion) of the neural network, a plurality of potential images. The generation network includes at least one depth wise and point wise convolution layer. For example, the neural network performs depth wise convolution on one or more layers of the neural network using one or more non-color information corresponding to the first frame and computed by the GPU. The generator network may use as input both the plurality of color component values and the depth information of each color component of the plurality of color component values.

Generating the second image also includes identifying, via a discriminator network (or a discriminator portion) of the neural network, at least one of the plurality of potential images as the second image. For example, the identification of the second image may be based on the loss function that assesses how “real” or “fake” the potential images look in comparison with reference images.

In certain aspects, the loss function determines a discriminator loss value based on a cross entropy function of a fake relative and a cross entropy function of a real relative. The fake relative is a sigmoid function of a logit function of fake determinations and a mean value of a logit function of real determinations. The real relative is a sigmoid function of the logit function of real determinations a mean value of the logit function of fake determinations. The discriminator network may operate with the loss function as a last layer of the discriminator network to enable full scale features comparison.

In certain aspects, the modified SRGAN may be examined by performing analyses discussed below. In general, super resolution algorithms are lossy. The discriminator network compares the final buffer with a reference frame rendered at high resolution. For example, the modified SRGAN may be identified in low level flow inspection. During low level flow inspections, the GPU may allow draw call captures. Existence of any super resolution processing includes additional calls to GPU, MLIP or similar sub systems. The modified SRGAN may by identified by performing MLIP (NPU) traffic analysis. For example, followed by additional processing after draw call, the discriminator network may inspect the traffic to NPU. By dumping and analyzing the inputs and outputs, the neural network processor may identify further details of the modified SRGAN. The modified SRGAN may be identified using custom tests. Once existence of a super-resolution is confirmed, a customized test application may be used to further confirm usage of our solution internally. This application can analyze the dumps collected across subsystems (like GPU, NPU) and confirms the usage of GPU specific features, similarity of generated frames.

In one configuration, a method or apparatus for graphics processing is provided. The apparatus may be a CPU, a GPU, or some other processor that can perform graphics processing, coupled with a neural network for super resolution operations. In one aspect, the apparatus may be the GPU 120 within the device 104 coupled with the neural network, or may be some other hardware within device 104 or another device. The apparatus may include means for rendering, by the GPU, a first image using a subset of data in a frame buffer corresponding to a first frame, the first image being rendered at a first resolution, the first image comprising a plurality of color component values. The apparatus may include means for generating, using a neural network, a second image corresponding to a higher resolution version of the first image, the second image having a second resolution higher than the first resolution, wherein the neural network uses as input the first image and one or more non-color information corresponding to the first frame and computed by the GPU. The apparatus may include means for outputting the second image for display.

### Example Aspects

Aspect 1: A method for rendering graphics, comprising: rendering, by a graphics processing unit (GPU), a first image using a subset of data in a frame buffer corresponding to a first frame, the first image being rendered at a first resolution, the first image comprising a plurality of color component values; generating, using a neural network, a second image corresponding to a higher resolution version of the first image, the second image having a second resolution higher than the first resolution, wherein the neural network uses as input the first image and one or more non-color information corresponding to the first frame and computed by the GPU; and outputting the second image for display.

Aspect 2: The method of Aspect 1, wherein the one or more non-color information in the frame buffer corresponding to the first frame comprise at least one of depth information, texture information, or normal information.

Aspect 3: The method of Aspect 1 or 2, wherein generating the second image comprises performing depth wise convolution on one or more layers of the neural network using the one or more non-color information corresponding to the first frame and computed by the GPU.

Aspect 4: The method of any of Aspects 1-3, wherein the one or more non-color information includes computation results outputted by the GPU based on commands sent from a central processing unit (CPU).

Aspect 5: The method of any of Aspects 1-4, wherein the depth information includes depth information of each color component of the plurality of color component values.

Aspect 6: The method of any of Aspects 1-5, wherein generating, using the neural network, the second image comprises providing the neural network: the plurality of color component values and the depth information of each color component of the plurality of color component values.

Aspect 7: The method of any of Aspects 1-6, wherein generating, using the neural network, the second image comprises: generating, via a generation network of the neural network, a plurality of potential images, wherein the generation network comprises a depth wise and point wise convolution layer; and identifying, via a discriminator network of the neural network, at least one of the plurality of potential images as the second image.

Aspect 8: The method of any of Aspects 1-7, wherein the discriminator network identifies the at least one of the plurality of potential images as the second image using a loss function, the loss function determining a discriminator loss value based on a cross entropy function of a fake relative and a cross entropy function of a real relative, wherein: the fake relative is a sigmoid function of a logit function of fake determinations and a mean value of a logit function of real determinations; and the real relative is a sigmoid function of the logit function of real determinations a mean value of the logit function of fake determinations.

Aspect 9: The method of any of Aspects 1-8, wherein the discriminator network operates with the loss function as a last layer of the discriminator network to enable full scale features comparison.

Aspect 10: An apparatus for graphics processing, comprising: a communication interface in communication with a neural network processor; a graphics processing unit (GPU) configured to: render a first image using a subset of data in a frame buffer corresponding to a first frame, the first image being rendered at a first resolution, the first image comprising a plurality of color component values; compute one or more non-color information corresponding to the first frame; and provide the one or more non-color information to the neural network processor for generating a second image corresponding to a higher resolution version of the first image, the second image having a second resolution higher than the first resolution, wherein the neural network processor uses as input the first image and one or more non-color information corresponding to the first frame and computed by the GPU; and a display processing unit configured to output the second image for display.

Aspect 11: The apparatus of Aspect 10, wherein the one or more non-color information in the frame buffer corresponding to the first frame comprise at least one of depth information, texture information, or normal information.

Aspect 12: The apparatus of Aspect 10 or 11, wherein the GPU is further configured to provide the one or more non-color information corresponding to the first frame to the neural network processor for performing depth wise convolution in order to generate the second image.

Aspect 13: The apparatus of any of Aspects 10-12, further comprises a central processing unit (CPU) configured to send commands to the GPU to compute the one or more non-color information.

Aspect 14: The apparatus of any of Aspects 10-13, wherein the depth information includes depth information of each color component of the plurality of color component values.

Aspect 15: The apparatus of any of Aspects 10-14, wherein the GPU is further configured to provide the neural network processor the plurality of color component values and the depth information of each color component of the plurality of color component values for generating the second image.

Aspect 16: The apparatus of any of Aspects 10-15, wherein the neural network processor comprises: a generator configured to generate a plurality of potential images, wherein the generation network comprises a depth wise and point wise convolution layer, wherein the GPU provides the generation network the one or more non-color information; and a discriminator configured to identify at least one of the plurality of potential images as the second image.

Aspect 17: The apparatus of any of Aspects 10-16, wherein the discriminator identifies the at least one of the plurality of potential images as the second image using a loss function, the loss function determining a discriminator loss value based on a cross entropy function of a fake relative and a cross entropy function of a real relative, wherein: the fake relative is a sigmoid function of a logit function of fake determinations and a mean value of a logit function of real determinations; and the real relative is a sigmoid function of the logit function of real determinations a mean value of the logit function of fake determinations.

Aspect 18: The apparatus of any of Aspects 10-17, wherein the discriminator operates with the loss function as a last layer of the discriminator to enable full scale features comparison.

Aspect 19: A computing device for graphics processing, comprising: a central processing unit (CPU); a communication interface in communication with a neural network processor; a graphics processing unit (GPU) configured to: render a first image using a subset of data in a frame buffer corresponding to a first frame, the first image being rendered at a first resolution, the first image comprising a plurality of color component values; compute one or more non-color information corresponding to the first frame; and provide the one or more non-color information to the neural network processor for generating a second image corresponding to a higher resolution version of the first image, the second image having a second resolution higher than the first resolution, wherein the neural network processor uses as input the first image and one or more non-color information corresponding to the first frame and computed by the GPU; and a display configured to output the second image.

Aspect 20: The computing device of Aspect 19, wherein the one or more non-color information in the frame buffer corresponding to the first frame comprise at least one of depth information, texture information, or normal information.

Aspect 21: The computing device of Aspect 19 or 20, wherein the GPU is further configured to provide the one or more non-color information corresponding to the first frame to the neural network processor for performing depth wise convolution in order to generate the second image.

Aspect 22: The computing device of any of Aspects 19-21, wherein the CPU is configured to send commands to the GPU to compute the one or more non-color information.

Aspect 23: The computing device of any of Aspects 19-22, wherein the depth information includes depth information of each color component of the plurality of color component values.

Aspect 24: The computing device of any of Aspects 19-23, wherein the GPU is further configured to provide the neural network processor the plurality of color component values and the depth information of each color component of the plurality of color component values for generating the second image.

Aspect 25: The computing device of any of Aspects 19-24, wherein the neural network processor comprises: a generator configured to generate a plurality of potential images, wherein the generation network comprises a depth wise and point wise convolution layer, wherein the GPU provides the generation network the one or more non-color information; and a discriminator configured to identify at least one of the plurality of potential images as the second image.

The subject matter described herein can be implemented to realize one or more benefits or advantages. For instance, the described graphics processing techniques can be used by a GPU, a CPU, or some other processor that can perform graphics processing to implement the state information techniques described herein. This can also be accomplished at a low cost compared to other graphics processing techniques. Moreover, the graphics processing techniques herein can improve or speed up data processing or execution. Further, the graphics processing techniques herein can improve resource or data utilization and/or resource efficiency.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method for rendering graphics, comprising:
rendering, by a graphics processing unit (GPU), a first image using a subset of data in a frame buffer corresponding to a first frame, the first image being rendered at a first resolution, the first image comprising a plurality of color component values;
generating, using a neural network, a second image corresponding to a higher resolution version of the first image, the second image having a second resolution higher than the first resolution, wherein the neural network uses as input the first image and one or more non-color information corresponding to the first frame and computed by the GPU; and
outputting the second image for display.

2. The method of claim 1, wherein the one or more non-color information in the frame buffer corresponding to the first frame comprise at least one of depth information, texture information, or normal information.

3. The method of claim 2, wherein generating the second image comprises performing depth wise convolution on one or more layers of the neural network using the one or more non-color information corresponding to the first frame and computed by the GPU.

4. The method of claim 2, wherein the one or more non-color information includes computation results outputted by the GPU based on commands sent from a central processing unit (CPU).

5. The method of claim 2, wherein the depth information includes depth information of each color component of the plurality of color component values.

6. The method of claim 5, wherein generating, using the neural network, the second image comprises providing the neural network: the plurality of color component values and the depth information of each color component of the plurality of color component values.

7. The method of claim 1, wherein generating, using the neural network, the second image comprises:
generating, via a generation network of the neural network, a plurality of potential images, wherein the generation network comprises a depth wise and point wise convolution layer; and
identifying, via a discriminator network of the neural network, at least one of the plurality of potential images as the second image.

8. The method of claim 7, wherein the discriminator network identifies the at least one of the plurality of potential images as the second image using a loss function, the loss function determining a discriminator loss value based on a cross entropy function of a fake relative and a cross entropy function of a real relative, wherein:
the fake relative is a sigmoid function of a logit function of fake determinations and a mean value of a logit function of real determinations; and
the real relative is a sigmoid function of the logit function of real determinations a mean value of the logit function of fake determinations.

9. The method of claim 8, wherein the discriminator network operates with the loss function as a last layer of the discriminator network to enable full scale features comparison.

10. An apparatus for graphics processing, comprising:
a communication interface in communication with a neural network processor;
a graphics processing unit (GPU) configured to:
render a first image using a subset of data in a frame buffer corresponding to a first frame, the first image being rendered at a first resolution, the first image comprising a plurality of color component values;
compute one or more non-color information corresponding to the first frame; and
provide the one or more non-color information to the neural network processor for generating a second image corresponding to a higher resolution version of the first image, the second image having a second resolution higher than the first resolution, wherein the neural network processor uses as input the first image and one or more non-color information corresponding to the first frame and computed by the GPU; and
a display processing unit configured to output the second image for display.

11. The apparatus of claim 10, wherein the one or more non-color information in the frame buffer corresponding to the first frame comprise at least one of depth information, texture information, or normal information.

12. The apparatus of claim 11, wherein the GPU is further configured to provide the one or more non-color information corresponding to the first frame to the neural network processor for performing depth wise convolution in order to generate the second image.

13. The apparatus of claim 11, further comprises a central processing unit (CPU) configured to send commands to the GPU to compute the one or more non-color information.

14. The apparatus of claim 11, wherein the depth information includes depth information of each color component of the plurality of color component values.

15. The apparatus of claim 14, wherein the GPU is further configured to provide the neural network processor the plurality of color component values and the depth information of each color component of the plurality of color component values for generating the second image.

16. The apparatus of claim 10, wherein the neural network processor comprises:
a generator configured to generate a plurality of potential images, wherein the generation network comprises a depth wise and point wise convolution layer, wherein the GPU provides the generation network the one or more non-color information; and
a discriminator configured to identify at least one of the plurality of potential images as the second image.

17. The apparatus of claim 16, wherein the discriminator identifies the at least one of the plurality of potential images as the second image using a loss function, the loss function determining a discriminator loss value based on a cross entropy function of a fake relative and a cross entropy function of a real relative, wherein:
the fake relative is a sigmoid function of a logit function of fake determinations and a mean value of a logit function of real determinations; and
the real relative is a sigmoid function of the logit function of real determinations a mean value of the logit function of fake determinations.

18. The apparatus of claim 17, wherein the discriminator operates with the loss function as a last layer of the discriminator to enable full scale features comparison.

19. A computing device for graphics processing, comprising:
a central processing unit (CPU);
a communication interface in communication with a neural network processor;
a graphics processing unit (GPU) configured to:
render a first image using a subset of data in a frame buffer corresponding to a first frame, the first image being rendered at a first resolution, the first image comprising a plurality of color component values;
compute one or more non-color information corresponding to the first frame; and
provide the one or more non-color information to the neural network processor for generating a second image corresponding to a higher resolution version of the first image, the second image having a second resolution higher than the first resolution, wherein the neural network processor uses as input the first image and one or more non-color information corresponding to the first frame and computed by the GPU; and
a display configured to output the second image.

20. The computing device of claim 19, wherein the one or more non-color information in the frame buffer corresponding to the first frame comprise at least one of depth information, texture information, or normal information.

21. The computing device of claim 20, wherein the GPU is further configured to provide the one or more non-color information corresponding to the first frame to the neural network processor for performing depth wise convolution in order to generate the second image.

22. The computing device of claim 21, wherein the CPU is configured to send commands to the GPU to compute the one or more non-color information.

23. The computing device of claim 22, wherein the depth information includes depth information of each color component of the plurality of color component values.

24. The computing device of claim 23, wherein the GPU is further configured to provide the neural network processor the plurality of color component values and the depth information of each color component of the plurality of color component values for generating the second image.

25. The computing device of claim 19, wherein the neural network processor comprises:
a generator configured to generate a plurality of potential images, wherein the generation network comprises a depth wise and point wise convolution layer, wherein the GPU provides the generation network the one or more non-color information; and
a discriminator configured to identify at least one of the plurality of potential images as the second image.
